(19) United States
(12) Patent Application Publication
(10) Pub. No.: US 2024/0072887 A1
(43) Pub. Date: Feb. 29, 2024

(54) ACCESS METHOD, AUXILIARY INFORMATION PROCESSING METHOD AND APPARATUS, DEVICE, AND STORAGE MEDIUM

(71) Applicant: Beijing Xiaomi Mobile Software Co., Ltd., Beijing (CN)

(72) Inventors: Yi XIONG, Beijing (CN); Xiaolong LI, Beijing (CN)

(73) Assignee: Beijing Xiaomi Mobile Software Co., Ltd., Beijing (CN)

(21) Appl. No.: 18/270,930

(22) PCT Filed: Jan. 5, 2021
(86) PCT No.: PCT/CN2021/070359

§ 371 Date: Jul. 5, 2023

(51) Int. Cl. H04B 7/185

(52) U.S. Cl. CPC H04B 7/18513

(57) ABSTRACT

An access method, which is performed by a UE, includes: receiving auxiliary information for a UE to access an NTN; and according to position information of the UE and the auxiliary information, determining time information of accessing to a target satellite.

### CROSS REFERENCE TO RELATED APPLICATION

The present application is a U.S. National Stage of International Application No. PCT/CN2021/070359, filed on Jan. 5, 2021, the contents of all of which are incorporated herein by reference in their entireties for all purposes.

### BACKGROUND

Non-terrestrial Networks (NTN) are introduced in the 5th Generation (5G) mobile communication system. In the current research, the NTN support two scenarios, namely, an earth fixed cell and an earth moving cell.

### SUMMARY

The embodiments of the present disclosure provide an access method, an auxiliary information processing method and apparatus, a device, and a storage medium.

According to a first aspect of the embodiments of the present disclosure, an access method is provided. The access method is performed by User Equipment (UE) and includes: receiving auxiliary information for the UE to access to NTN; and determining time information for accessing to a target satellite according to position information of the UE and the auxiliary information.

According to a second aspect of the embodiments of the present disclosure, an auxiliary information processing method is provided. The auxiliary information processing method is performed by a network and includes: sending auxiliary information for UE to access to NTN, where the auxiliary information is configured for the UE to determine time information for accessing to a target satellite in a preset cell according to self position information.

According to a third aspect of the embodiments of the present disclosure, a communication device is provided. The communication device includes a processor, a transceiver, a memory, and executable programs stored in the memory and can be executed by the processor, where when executing the executable programs, the processor performs the method provided by the first aspect or the second aspect.

According to a fourth aspect of the embodiments of the present disclosure, a computer storage medium is provided. The computer storage medium stores executable programs; and when the executable programs are executed by a processor, the method provided by the first aspect or the second aspect can be implemented.

It should be understood that the above general description and the following detailed description are only illustrative and explanatory, and cannot limit the embodiments of the present disclosure.

### BRIEF DESCRIPTION OF THE DRAWINGS

The accompanying drawings are incorporated into the specification and constitute a part of the specification, show embodiments consistent with the present disclosure, and are used to explain the principle of the embodiments of the present disclosure together with the specification.

FIG. 1 is a schematic structural diagram of a radio communication system according to an example.

FIG. 2A is a schematic structural diagram of an NTN according to an example.

FIG. 2B is a schematic diagram of a comparison of signal receiving intensity of TN and NTN to near UE and far UE according to an example.

FIG. 3 is a schematic flowchart of an access method according to an example.

FIG. 4A is a schematic diagram of coverage of a preset cell according to an example.

FIG. 4B is a schematic diagram of coverage of a preset cell according to an example.

FIG. 5 is a schematic flowchart of an auxiliary information processing method according to an example.

FIG. 6 is a schematic structural diagram of a UE access apparatus according to an example.

FIG. 7 is a schematic structural diagram of an auxiliary information processing apparatus according to an example.

FIG. 8A is a schematic diagram of transformation of a coverage area of a target satellite according to an example.

FIG. 8B is a schematic diagram of an enlarged view of a schematic diagram of coverage of FIG. 8A at a moment.

FIG. 8C is a schematic diagram of an enlarged view of a schematic diagram of coverage of FIG. 8B at a moment.

FIG. 9 is a schematic structural diagram of UE according to an example.

FIG. 10 is a schematic structural diagram of a network device according to an example.

### DETAILED DESCRIPTION

Illustrative embodiments will be described in detail here, and examples of them are shown in the accompanying drawings. When the following descriptions refer to the figures, the same numbers in different figures indicate the same or similar elements, unless otherwise indicated. The implementations described in the following examples do not represent all implementations consistent with the embodiments of the present disclosure. Instead, they are merely examples of apparatuses and methods consistent with some aspects of the embodiment of the present disclosure as detailed in the appended claims.

The terms used in the embodiments of the present disclosure are only for the purpose of describing specific embodiments, and are not intended to limit the embodiments of the present disclosure. The singular forms such as “a/an” and “the” used in the embodiments of the disclosure and the appended claims are also intended to include the plural forms, unless otherwise clearly stated in the context. It is to be further understood that the term “and/or” used herein refers to and includes any of one or more of the associated listed items or all possible combinations.

It is to be understood that although the terms such as first, second and third may be used to describe various information in the embodiments of the disclosure, the information is not intended to be limited to the terms. The terms are merely used to distinguish the same type of information from each other. For instance, without departing from the scope of the embodiments of the disclosure, first information can also be called second information, and similarly, second information can also be called first information. Depending on the context, the word “if” as used here may be interpreted as “when” or “upon” or “in response to determining”.

The disclosure provides a technical solution, relates to the technical field of radio communications but are not limited to the technical field of radio communications, and in particular to, an access method, an auxiliary information processing method and apparatus, a device, and a storage medium.

Referring to FIG. 1, it shows a schematic structural diagram of a radio communication system according to an embodiment of the present disclosure. As shown in FIG. 1, the radio communication system is a communication system based on a cellular mobile communication technology and may include: a plurality of UE 11 and a plurality of base stations 12.

The UE 11 may refer to a device for providing voice and/or data connectivity for a user. The UE 11 may be in communication with one or more core networks via a Radio Access Network (RAN), and the UE 11 may be an Internet of Things UE, such as a sensor device, a mobile phone (or “cellular” phone), and a computer having the Internet of Things UE, for example, may be a fixed, portable, pocket, handheld, computer built-in, or vehicle-mounted apparatus. For example, a station (STA), a subscriber unit, a subscriber station, a mobile station, a mobile table, a remote station, an access point, a remote UE, an access UE, a user terminal, a user agent, a user device, or user equipment (UE). The UE 11 may also be a device of an unmanned aerial vehicle. The UE 11 may also be a vehicle-mounted device, for example, may be a trip computer having a radio communication function, or may be a radio communication device connected to the trip computer externally. The UE 11 may be a roadside device, and for instance, may be a street lamp having a radio communication function, a signal lamp, or other roadside devices.

The base station 12 may be a network device in the radio communication system. The radio communication system may be the 4G mobile communication system, also referred to as a Long Term Evolution (LTE) system; or, the radio communication system may also be a 5G system, also referred to as a New Radio (NR) system or a 5G NR system. The radio communication system may also be a next generation system of the 5G system. An access network in the 5G system may be referred to as a New Generation-Radio Access Network (NG-RAN). Or an MTC system.

The base station 12 may be an evolved base station (eNB) used in the 4G system. Or the base station 12 may also be a base station (gNB) using a centralized distribution architecture in the 5G system. When the base station 12 uses the concentrated distribution architecture, a Central Unit (CU) and at least two Distributed Units (DU) are included usually. The CU is provided with protocol stacks of a Packet Data Convergence Protocol (PDCP) stratum, a Radio Link Control (RLC) protocol stratum, and a Media Access Control (MAC) stratum; and the DU is provided with a protocol stack of a Physical (PHY) stratum, and the embodiments of the present disclosure do not limit the specific implementations of the base station 12.

Radio connection between the base station 12 and the UE 11 may be established by means of a wireless air interface. In different implementations, the wireless air interface is a wireless air interface based on the 4G standard, or the wireless air interface is a wireless air interface based on the 5G standard. For example, the wireless air interface is a new radio; or the wireless air interface may also be a wireless air interface based on a further next generation mobile communication network technology standard of 5G.

In some embodiments, end to end (E2E) connection may further be established between the UE 11. For example, scenarios such as Vehicle to Vehicle (V2V) communication, Vehicle to Infrastructure (V2I) communication, and Vehicle to Pedestrian (V2P) communication in Vehicle to Everything (V2X) communication.

In some embodiments, the radio communication system may further include a network management device 13.

The plurality of base stations 12 are connected with the network management device 13 respectively. Where the network management device 13 may be a core network device of the radio communication system, for example, the network management device 13 may be a Mobility Management Entity (MME) in an Evolved Packet Core (EPC) network, Or the network management device may also be other core network devices, such as a Serving Gateway (SGW), a Public Data Network Gateway (PGW), a Policy and Charging Rules Function (PCRF) unit, or a Home Subscriber Server (HSS). The embodiments of the present disclosure do not limit an implementation form of the network management device 13.

With respect to an earth moving cell on the ground based on a Low Earth Orbit (LEO) satellite, an earth fixed cell based on the LEO means that the cell is fixed with respect to a certain position on the earth for a certain time. This may be realized by the satellite generating a steerable beam fixed on the ground. For a communication scenario of the earth fixed cell, when the elevation angle of a serving LEO satellite observed by the UE in the cell is about to be lower than a threshold of the minimum elevation angle, all UE in the cell are about to lose coverage of the satellite, and need to access a new cell of satellite. Therefore, even if the UE is stationary with respect to the ground, the scenario of the earth fixed cell still requires mobility management in order to guarantee service continuity of the NTN in consideration of the mobility of the satellite. In order to meet the above requirement for the UE to access to the new cell, there is enough time for overlapping coverage between two LEO satellites at a certain point on the earth, so that a large number of UEs in the cell have enough time to leave the cell covered by the original satellite and access to the cell of the new satellite.

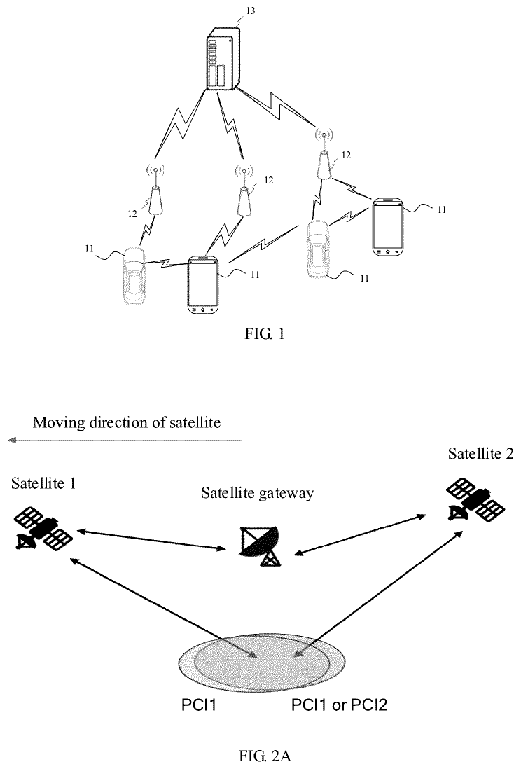

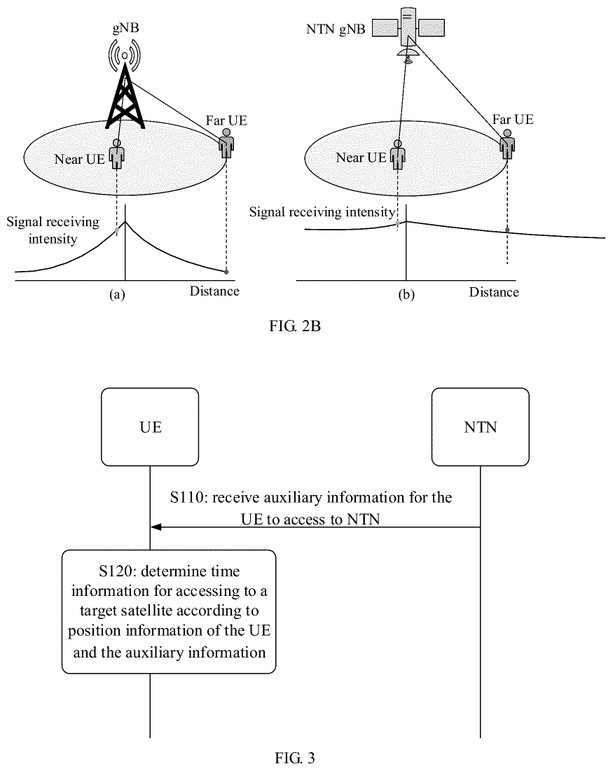

As shown in FIG. 2A, in a communication scenario of the earth fixed cell, with the movement of the satellite, the satellite can only serve a fixed area on the ground for a certain period of time, and at a certain time, the UE in the area needs to perform Service Link Switch (SLS) due to the departure of the satellite, so as to access a new satellite. As shown in FIG. 2A, assuming that a satellite 1 and a satellite 2 both move in the same direction, the satellite 1 and the satellite 2 switch during the coverage process of cells PCI1 and PCI2.

As shown in FIG. 2B, in a Terrestrial Networks (TN) system, UE can determine whether it is near the edge of the cell according to obvious difference of Reference Signal Received Power (RSRP) or Reference Signal Received Quality (RSPQ) between the center of the cell and the edge of the cell. For signals transmitted by the gNB, the attenuation of the signal receiving intensity to near UE and far UE is obvious from the center of the cell to the edge of the cell. However, in the NTN, the radius of the cell is large, the UE is in the center or edge of the cell (i.e., near UE and far UE), the difference of RSRP/RSRQ is small, and the near and far effect is not obvious. Therefore, switch triggering based on signal intensity in the TN is not applicable to the NTN. In related art, location-based Conditional Handover (CHO) trigger events and time/timer-based trigger events are introduced in the NTN.

When time/timer-based CHO trigger events are adopted in the SLS, the UE needs to report its own location, and the network sets the CHO trigger time and timer duration according to the position information reported by the UE. However, considering the privacy of the UE, it may not be supported for the UE to report its own position information in the NTN.

In view of this, as shown in FIG. 3, an embodiment of the present disclosure provides an access method. The access method is performed by UE, the UE receives the auxiliary information for accessing to the NTN from the network of the NTN, and the auxiliary information may be determined according to ephemeris information of the target satellite but does not contain the ephemeris information. In such a case, the UE can determine the time information for accessing to the target satellite by combining with self position information and the auxiliary information without reporting self position information, so that transmission of the position information of the UE and the ephemeris information of the target satellite during a Service Link Switch (SLS) process performed by the UE is reduced, privacy of the position information of the UE and the ephemeris information of the target satellite is protected, and security of the position information of the UE and/or the ephemeris information of the target satellite is improved.

The access method includes the following steps S110 and S120.

In S110, auxiliary information for the UE to access to NTN is received.

Then in S120, time information for accessing to a target satellite is determined according to position information of the UE and the auxiliary information.

The auxiliary information may be determined according to ephemeris information of the target satellite by the NTN but does not contain the ephemeris information of the target satellite.

The UE may receive the auxiliary information issued by the NTN, which may be issued by a current serving satellite of the UE or a current original satellite covering a preset cell. The serving satellite may be the satellite currently accessed by the UE.

The target satellite may be the next satellite to be accessed by the UE. The serving satellite and/or the target satellite here may be both LEO satellites, but are not limited to LEO satellites. The preset cell may include, but is not limited to, an earth fixed cell.

In the embodiment of the present disclosure, the UE determines time information for accessing to the target satellite by combining with self position information after receiving the auxiliary information. The time information may be any time information for the UE to determine when it may access to the target satellite, and/or time information for the UE to determine at which time period or for how long it may access to the target satellite.

Through issuing of auxiliary information without the ephemeris information of the target satellite, the UE can easily determine the time information for accessing to the target satellite without reporting self position information or knowing the ephemeris information of the target satellite, so that leakage in the transmission process of the position information of the UE and/or the ephemeris information of the target satellite is reduced, and security of the ephemeris information of the target satellite and/or the position information of the UE is improved.

In an embodiment, the auxiliary information includes at least one of the following: a cell identity of a preset cell, where the preset cell is: the cell where the UE is located when accessing to the target satellite; change information of the coverage area of the target satellite; corresponding relationship information between the change information and access time parameter; where the access time parameter indicates the time parameter for the UE to access to the target satellite in the preset cell; starting time information of an access timer accessing to the target satellite; duration information of public duration, where the public duration includes: duration from a preset time to a predicted time when the target satellite passes through a first reference position of the preset cell; or reference point information which is the position information of a second reference position of the preset cell.

The preset cell may be: the cell where the UE is located currently and/or the cell where determined or predicated by the UE according to self mobility information when accessing to the target satellite.

The cell identity may be cell Identification (ID), for example, the cell identity may be a Physical Cell ID (PCI) of the preset cell.

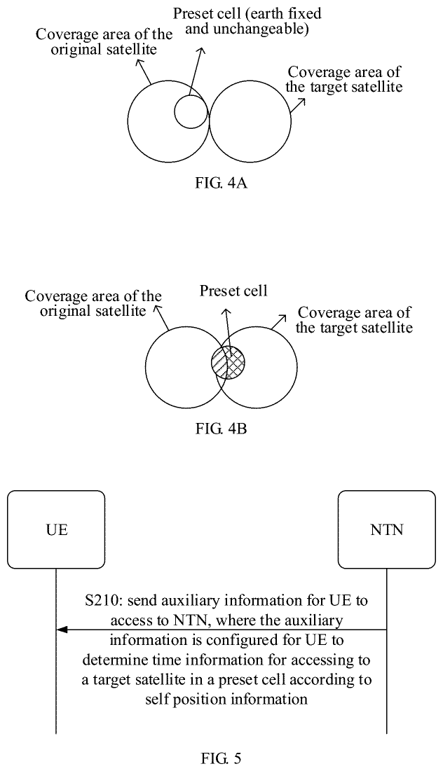

Referring to FIGS. 4A and 4B, the coverage area of the original satellite and the coverage area of the target satellite may be larger than the area of the preset cell. If the preset cell is an earth fixed cell (or earth stationary cell), as shown in FIG. 4, the current preset cell is covered by the original satellite. As time goes by, both the original satellite and the target satellite move, by the time shown in FIG. 4B, a part of the preset cell is covered by both the original satellite and the target satellite, and the other part of the preset cell is only covered by the target satellite.

If the UE is located in the preset cell, if the cell identity of the preset cell remains unchanged, the UE needs to switch a service link from the original satellite to the target satellite, and then the time information that the target satellite can access needs to be acquired. In another embodiment, the preset cell is stationary on the ground, but the cell identity of the preset cell may also change along with change of the covering satellite, for example, the PCI when the target satellite covers the preset cell is different from that when the original satellite covers the preset cell.

The auxiliary information may also include: the change information of the coverage area of the target satellite, which reflects the change situation of the coverage area of the target satellite in the time domain. The change information may be determined according to ephemeris information of the target satellite, but is not the ephemeris information of the target satellite.

At this time, if the UE receives the change information, according to the historical access information of the UE when accessing to the target satellite, in combination with the change information and self position information, when the UE is located in a coverage area of the target satellite, in combination with the historical access information in the coverage area, etc., the access time in the corresponding coverage area of the corresponding target satellite and the like may be determined, and the time information when accessing to the target satellite in the preset cell may be determined.

For another example, the UE may receive access configuration information from the network of the NTN besides the auxiliary information, which can at least indicate the time information of accessing to a coverage area of the target satellite in the preset cell, and then the time offset when accessing to different coverage areas is obtained by combining with the change information, so that the UE can determine the time information of accessing to each coverage area of the target satellite in the coverage area.

For example, the change information of the coverage area of the target satellite may include: a list formed by the area information of the area (that is, the coverage area) capable of being covered by the target satellite in a period

Corresponding relationship information between the change information and access time parameter, the corresponding relationship information indicating the corresponding relationship between the coverage area of the target satellite and the time parameters for accessing the target satellite in the corresponding coverage area of the target satellite.

In this way, if the UE receives the corresponding relationship, according to the corresponding relationship between the coverage area and the access time parameter, in combination with that whether self position is in the corresponding coverage area, which area of the preset cell the UE is in may be determined, and/or whether the position of the UE can access to the target satellite, and/or specifically, when it may access to the target satellite, and the like may be determined.

The access timer may be: a timer accessing to the target satellite.

In an embodiment, the auxiliary information may further include: starting time information of the access timer. Due to large coverage area of the satellite cell, the transmission delay for different UEs receiving information transmitted by the same satellite is different, compared with the phenomenon that the UE directly starts the access timer after receiving the auxiliary information or the timing information of the access timer. The starting time difference of the access timer is formed between different UEs. The auxiliary information in the embodiment of the present disclosure carries the starting time information of the access timer. The starting time information indicates the starting time of the access timer. In this way, the auxiliary information can realize the consistency of the starting time of access timers started by different UEs by carrying the starting time information.

In an embodiment, the access timer may be a timer for the UE to determine the time information for accessing to the target satellite, for example, the UE may access to the target satellite during the operating time range of the access timer, or the UE may access to the target satellite when the access timer times out. The above are only examples that the access timer determines the time information accessing to the target satellite for the UE, and specific implementations are not limited to this.

In an embodiment, the corresponding relationship information between the change information and the access time parameter indicates at least one of the following: the corresponding relationship between the coverage area of the target satellite and the access time; the corresponding relationship between the coverage area of the target satellite and the timing duration of the access timer; or the corresponding relationship between the coverage area of the target satellite and adjustment parameters of the access timer, where the adjustment parameter indicates the adjustment parameter of the access timer relative to the public duration.

For example, the area covered by the target satellite during operation is divided into N coverage areas. Then the corresponding relationship information between the transformation information and the access time parameter indicates the corresponding relationship between the coverage area of the target satellite and the access time, which may include: the corresponding relationship between the N coverage areas and the access time corresponding to the N coverage areas respectively.

The access time can be an absolute time. The absolute time includes, but is not limited to, being indicated by Universal Time Coordinated (UTC) or time of a certain area, such as Beijing time or Tokyo time.

In an embodiment, the public duration may be the waiting public duration for all UEs in the preset cell to access the target cell. If the UE waits for the public duration, the target satellite may cover the whole preset cell, and all UEs in the preset cell can access to the target satellite.

In another embodiment, the target satellite is mobile relative to the preset cell on the ground, and the UE at the edge of the preset cell may actually be able to access the target cell without waiting for the public duration. In an embodiment, an access timer is further introduced; and the timing duration of the access timer may be determined according to the public duration. Specifically, as for how to determine the timing duration according to the public duration, it can be determined according to adjustment parameters. The adjustment parameters may be configured to adjust the public duration, and the adjustment result can be the timing duration of the access timer.

In some embodiments, the adjustment parameters include: offset amount; and/or scaling proportion.

The offset amount may be used for addition and subtraction with the public duration, so as to obtain the timing duration of the access timer corresponding to the position of the UE.

The scaling proportion may be used for multiplication with the public duration, so as to obtain the timing duration of the access timer corresponding to the position of the UE.

In an embodiment, the public duration: the duration between predicted time when the target satellite passes by the first reference position of the preset cell, as determined according to ephemeris information of the target satellite and the preset time.

The first reference position here may be any position in the preset cell, for example, the position of the center point of the preset cell, or the position of the point with the lowest current distance from the target satellite in the preset cell. In short, the first reference location here may be any position preset in the preset cell.

The reference point position information may be the position of the second reference point in the preset cell, similarly, the second reference point here may be the cell center point or edge point at the edge position of the preset cell.

In the embodiment of the disclosure, the first reference point and the second reference point may be the same or different.

In an embodiment, the preset time includes: current time; or, receiving time for configuration switch of the service link.

The current time may be: the current time when the auxiliary information is issued. The receiving time for configuration switch of the service link is: the time when the UE receives the configuration switch of the service link. The configuration switch of the service link is configured to indicate the UE to switch the service link.

The service link is a link between the UE and the service satellite.

In some embodiments, the change information of the coverage area of the target satellite includes: a sequence of area information of a plurality of coverage areas passed by the target satellite in sequence.

For example, the target satellite will successively pass by and cover area A, area B, area C, and area D for a preset period of time in the future. Area information of the area A, area B, area C and area D is sequentially sorted in the time domain to form a sequence.

At this time, the UE receives the sequence composed of the area information, so that the area that will be covered by the target satellite for the preset time in the future can be known without knowing the ephemeris information of the target satellite. And if the UE happens to be in the coverage area of the target satellite when the target satellite passes by, it can access to the target satellite. When accessing to the target satellite, the UE can access to the cell formed by the target satellite through a cell switching request, or access to the target satellite through SLS without switching the cell.

In some embodiments, the area information may be expressed as one of the following: the position information of the pole position of the polar coordinate system, the axial direction of the polar coordinate system, and the polar coordinates of the coverage area in the polar coordinate system; latitude and longitude of the coverage area; coordinates of the coverage area in the world coordinate system; or position information of a reference position and distance information of a reference distance of the coverage area.

The area information of the coverage area of the target satellite can be various, the above is only an example, and the specific implementation is not limited to any of the above examples.

For example, area information of the coverage area of the target satellite is indicated by the polar coordinate system. It is also possible to indicate the coordinate system to describe the area information of the coverage area of the target satellite.

If polar coordinates are used to describe the coverage area of the target satellite, the polar angle range can be used to determine whether the UE is in the coverage area of the target satellite in the preset cell or not.

For example, when the polar angle range corresponding to the coverage area of the target satellite is smaller than or equal to π, the UE determines that the UE is located in the coverage area by judging whether self position is within the polar angle range corresponding to a certain coverage area of network configuration or not and the projection of the connecting line segment between the position of the UE and pole position on the angle bisector of the angle where the coverage area is located is greater than or equal to a reference distance. Otherwise, it is judged that the UE is not located in the area.

When the polar angle range is greater than π, the UE determines that the UE is located in the coverage area by judging whether its position is within the polar angle range corresponding to a certain coverage area of network configuration or not, or the projection of the connecting line segment between the position of the UE and pole position on the angle bisector of the angle where the coverage area is located is smaller than or equal to a reference distance. Otherwise, it is judged that the UE is not located in the area.

For another example, area information of the coverage area of the target satellite is described by longitude and latitude.

In an embodiment, area information of a plurality of coverage areas passed by the target satellite in sequence may be indicated by coordinates of the world coordinate system.

The reference position of the coverage area may be any position determined in advance, for example, the center of the preset cell or any position on the ground. The position information of a sharp turn position and the distance information between the coverage area and the base station position are obtained, so that the UE can also know the area information of the coverage area of the target satellite.

For example, the pole position includes: the cell center of the preset cell; and/or, the axial direction includes: the projection direction of the moving direction of the satellite to the ground.

Here an illustrative example of the pole position and/or axial direction, in the specific implementation process, the pole position can also be the edge point closest to the target satellite currently or the edge point farthest from the target satellite currently in the preset cell. The axial direction can also be: the connecting line direction that the target satellite points to the center of the earth.

The above are only examples of the pole position and/or the axial direction, and specific implementations are not limited thereto.

In an embodiment, the reference position includes: the first coverage position of the target satellite over the preset cell; and/or, the reference distance includes: the nearest distance of the coverage area of the satellite from the reference position and the farthest distance of the coverage area of the satellite from the reference position.

The above is an example of the reference position, and specific implementations are not limited thereto.

In another embodiment, S120 of FIG. 3 may include:

In response to the auxiliary information including the corresponding relationship information between the change information and access time parameter, it is determined that the UE is located in the coverage area of the target satellite of the preset cell according to the position information of the UE, and time information for accessing to the target satellite is determined according to the access time parameter.

For example, that in response to the auxiliary information including the corresponding relationship information between the change information and access time parameter, it is determined that the UE is located in the coverage area of the target satellite of the preset cell according to the position information of the UE, and time information for accessing to the target satellite is determined according to the access time parameter includes at least one of the following:
in response to the corresponding relationship information that indicates the corresponding relationship between the coverage area of the target satellite and the access time, it is determined that the UE is located in the coverage area of the target satellite of the preset cell according to the position information of the UE, and it is determined that an access request for accessing into the target satellite is initiated at the access time;
in response to the corresponding relationship information that indicates the corresponding relationship between the coverage area of the target satellite and the timing duration of the access timer, it is determined that the UE is located in the coverage area of the target satellite of the preset cell according to the position information of the UE, and it is determined that an access request for accessing to the target satellite is initiated when the access timer times out; or
in response to the corresponding relationship information that indicates the corresponding relationship between the coverage area of the target satellite and adjustment parameters of the access timer, it is determined that the UE is located in the coverage area of the target satellite of the preset cell according to the position information of the UE, the timing duration of the access timer is determined according to the public duration and the adjustment parameter, and it is determined that an access request for accessing to the target satellite is initiated when the access timer times out.

If the corresponding relationships indicated by the corresponding relationship information are different, the UE may determine different time information according to the corresponding relationships when determining that the UE is located in the coverage area of the target satellite and/or is about to be located in the coverage area of the target satellite according to self position, for example, the an access time, the timing information of the access timer, and/or the adjustment parameter of the timing duration of the access timer with respect to the public duration are determined, and when the access time is reached or the access timer times out, it is requested to access to the target satellite.

In another embodiment, S120 may include:
in response to the auxiliary information including the change information of the coverage area of the target satellite, it is determined that the UE is located in the coverage area of the target satellite of the preset cell according to the position information of the UE and the change information of the coverage area of the target satellite, and time information for accessing to the target satellite in the preset cell is determined according to the time offset of the access time among a plurality of coverages areas of the target satellite and the access time of at least one of the coverage areas; or,
in response to the auxiliary information including the reference point information, the time information for the UE to access to the target satellite in the preset cell is determined according to the relative position relationship between the position information of the UE and a reference position indicated by the reference point information.

According to the relative position relationship, in combination with historical access data and of the target satellite and/or at least one of other configuration information of the target satellite, the UE can determine the time information for accessing to the target satellite in the preset cell without reporting self position information and/or knowing the ephemeris information of the target satellite.

In an embodiment, the time information for accessing to the target satellite in the preset cell includes the following: absolute time information for accessing to the target satellite in the preset cell; timer information of the access timer accessing to the target satellite in the preset cell; and/or the adjustment parameter of the timing duration of the access timer accessing to the target satellite in the preset cell relative to the public duration.

The absolute time information may directly indicate the access time for accessing to the target satellite in the preset cell.

In some other embodiments, the time information may also be the timer information of the access timer, which may include but is not limited to: starting time information and/or timing duration information of the access timer.

In another embodiment, the time information may also be the adjustment parameter of the access timer relative to the public duration, and the adjustment parameter here may be the offset amount and/or scaling proportion above-mentioned.

In another embodiment, S120 may include: it is determined that the UE is located in the preset cell according to the position information of the UE, and the access timer is started according to the starting time information of the access timer included in the auxiliary information; and accessing into the target satellite in the preset cell is performed when the access timer times out.

The UE can start the access timer immediately after receiving the auxiliary information, or start the access timer according to the starting time indicated by the starting time information carried by the auxiliary information; or, the access timer is started when an access configuration or configuration switch of the service link issued by the network of the NTN is received.

In short, there are various ways for determining the time point when the UE starts the access timer, and no matter which way is used to determine the starting time, when the access timer times out, the UE can access to the access procedure of the target satellite in the target cell.

The access procedure includes but is not limited to two stages: access control and/or random access.

In an embodiment, the method further includes: in response to the auxiliary information not including the starting time information of the access timer, the access timer is started when the configuration information of the target satellite is received. The configuration information here can be one of the access configuration and/or configuration switch of the service link above-mentioned.

Additionally or alternative, S120 may include: according to the duration of the access timer determined by the auxiliary information, when the access timer times out, it is determined that the UE is located in the preset cell according to the position information of the UE, and accessing into the target satellite is performed in the preset cell.

For example, in the embodiment of the disclosure, the absolute time indicated by the absolute time information in any of the foregoing embodiments includes: Universal Time Coordinated (UTC).

In an embodiment, auxiliary information for the UE to access to NTN is received includes: broadcast message containing the auxiliary information is received; and/or, radio resource control (RRC) massage containing the auxiliary information is received.

In an embodiment, the auxiliary information may be a broadcast message directed to a plurality of UEs, informing the plurality of UEs to access to the target satellite. For example, the broadcast message may be a message broadcast in the preset cell, and the preset cell may be a current serving cell of the UE.

In another embodiment, issuing of the auxiliary information through the RRC massage may be issuing of the auxiliary information at the UE granularity.

For example, the current serving satellite of the UE moves to the ground, the coverage area for the preset cell becomes smaller and smaller, and at this time, the UE may need to perform SLS. The RRC message may be an RRC message that triggers the UE to switch to the service link with the target satellite from the current one with the serving satellite. In this way, issuing of the auxiliary information is simply realized without introducing new messages, which has the characteristics of strong compatibility with the relevant art.

As shown in FIG. 5, an embodiment of the present disclosure provides an information processing method. The auxiliary information processing method is performed by a network and includes step S210.

In S210, auxiliary information for UE to access to the NTN is sent, where the auxiliary information is configured to determine time information for accessing to a target satellite in a preset cell by the UE according to self position information.

The auxiliary information processing method is performed by a network, which may be the network of the NTN. For example, the auxiliary information processing method is performed by a serving satellite of the UE.

The network issues the auxiliary information for accessing to the NTN to the UE, and the auxiliary information is determined according to ephemeris information of the target satellite but is not the ephemeris information of the target satellite.

The auxiliary information can be configured to determine the time information for accessing to the target satellite without reporting self position information. For example, the auxiliary information can be configured to determine time information for accessing to the target satellite in the preset cell issuing the auxiliary information without reporting self position information.

In an embodiment, the auxiliary information includes at least one of the following: a cell identity of a preset cell, where the preset cell is: the cell where the UE is located when accessing to the target satellite; change information of the coverage area of the target satellite; corresponding relationship information between the change information and access time parameter, where the access time parameter indicates the time parameter for the UE to access to the target satellite in the preset cell; starting time information of an access timer accessing to the target satellite; duration information of public duration, where the public duration includes: duration from a preset time to a predicted time when the target satellite passes through a first reference position of the preset cell; or reference point information which is the position information of a second reference position of the preset cell.

The relevant explanation of various information of the auxiliary information here can refer to the preceding embodiments and will not be repeated here.

In an embodiment, the corresponding relationship information between the change information and the access time parameter indicates at least one of the following: the corresponding relationship between the coverage area of the target satellite and the access time; the corresponding relationship between the coverage area of the target satellite and the timing duration of the access timer; or the corresponding relationship between the coverage area of the target satellite and adjustment parameters of the access timer, where the adjustment parameter indicates the adjustment parameter of the access timer relative to the public duration.

The relevant explanation of the corresponding relationship indicated by the corresponding relationship information herein can refer to the preceding embodiments and will not be repeated here.

For example, the adjustment parameters include: offset amount; and/or scaling proportion.

In an embodiment, the public duration: the duration between predicted time when the target satellite passes by the first reference position of the preset cell, as determined according to ephemeris information of the target satellite and the preset time.

For example, the public duration may be: currently oriented to all UEs in the cell that sends the auxiliary information and/or all UEs located in the preset cell.

For example, the preset time includes: current time; or, receiving time for configuration switch of the service link.

The current time at this time may be: the broadcasting time of the duration information of the public duration or the time when the UE receives the duration information.

Here, configuration switch of the service link may be configuration information indicating the UE to perform SLS, and the time when the UE receives the configuration switch of the service link may also be the preset time for timing the common duration.

In an embodiment, the change information of the coverage area of the target satellite includes: a sequence of area information of a plurality of coverage areas passed by the target satellite in sequence.

For example, the area information includes at least one of the following.

The area information may be expressed as one of the following: the position information of the pole position of the polar coordinate system, the axial direction of the polar coordinate system, and the polar coordinates of the coverage area in the polar coordinate system; latitude and longitude of the coverage area; coordinates of the coverage area in the world coordinate system; or position information of a reference position and distance information of a reference distance of the coverage area.

In an embodiment, the pole position includes: the cell center of the preset cell; and/or, the axial direction includes: the projection direction of the moving direction of the satellite to the ground.

In an embodiment, the reference position includes: the first coverage position of the target satellite over the preset cell; and/or the reference distance includes: the nearest distance of the coverage area of the satellite from the reference position and the farthest distance of the coverage area of the satellite from the reference position.

In an embodiment, auxiliary information for the UE to access to NTN is sent includes: broadcast information containing the auxiliary information is sent; or RRC information containing the auxiliary information is sent.

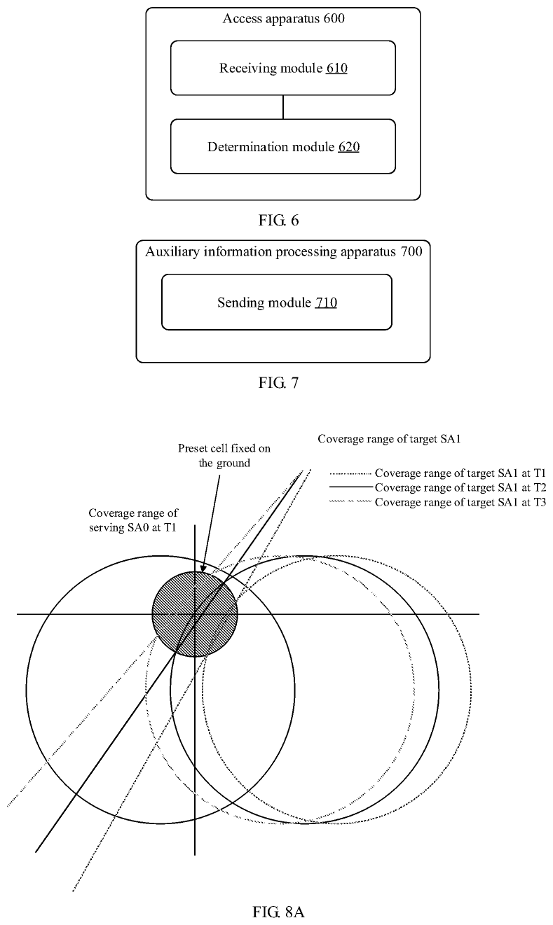

As shown in FIG. 6, an embodiment of the present disclosure provides an access apparatus 600. The access apparatus 600 is performed by UE and includes a receiving module 610 and a determination module 620.

The receiving module 610 is configured to receive auxiliary information for the UE to access to NTN.

The determination module 620 is configured to determine time information for accessing to a target satellite according to position information of the UE and the auxiliary information.

In an embodiment, the receiving module 610 and the determination module 620 include, but are not limited to, program module. After being executed by the processor, the program module can receive auxiliary information for accessing to the NTN, and determines time information for accessing to the target satellite by combining with self position information of the UE and the auxiliary information.

In an embodiment, the receiving module 610 and the determination module 620 include, but are not limited to, software and hardware combination module. The software and hardware combination module includes but is not limited to various programmable arrays; and the programmable array may include a complex programmable array or a field programmable array.

In another embodiment, the receiving module 610 and the determination module 620 may also be a pure hardware module; and the pure hardware module includes but is not limited to a specific integrated circuit.

In an embodiment, the auxiliary information includes at least one of the following: a cell identity of a preset cell, where the preset cell is: the cell where the UE is located when accessing to the target satellite; change information of the coverage area of the target satellite; corresponding relationship information between the change information and access time parameter, where the access time parameter indicates the time parameter for the UE to access to the target satellite in the preset cell; starting time information of an access timer accessing to the target satellite; duration information of public duration, where the public duration includes: duration from a preset time to a predicted time when the target satellite passes through a first reference position of the preset cell; or reference point information which is the position information of a second reference position of the preset cell.

In an embodiment, the corresponding relationship information between the change information and the access time parameter indicates at least one of the following: the corresponding relationship between the coverage area of the target satellite and the access time; the corresponding relationship between the coverage area of the target satellite and the timing duration of the access timer; or the corresponding relationship between the coverage area of the target satellite and adjustment parameters of the access timer; where the adjustment parameter indicates the adjustment parameter of the access timer relative to the public duration.

In an embodiment, the adjustment parameter includes: offset amount; and/or scaling proportion.

In an embodiment, the public duration: the duration between predicted time when the target satellite passes by the first reference position of the preset cell, as determined according to ephemeris information of the target satellite and the preset time.

In an embodiment, the preset time includes: current time; or, receiving time for configuration switch of the service link.

In an embodiment, the change information of the coverage area of the target satellite includes: a sequence of area information of a plurality of coverage areas passed by the target satellite in sequence.

In an embodiment, the area information may be expressed as one of the following: the position information of the pole position of the polar coordinate system, the axial direction of the polar coordinate system, and the polar coordinates of the coverage area in the polar coordinate system; latitude and longitude of the coverage area; coordinates of the coverage area in the world coordinate system; or position information of a reference position and distance information of a reference distance of the coverage area.

In an embodiment, the pole position includes: the cell center of the preset cell; and/or, the axial direction includes: the projection direction of the moving direction of the satellite to the ground.

In an embodiment, the reference position includes: the first coverage position of the target satellite over the preset cell; and/or, the reference distance includes: the nearest distance of the coverage area of the satellite from the reference position and the farthest distance of the coverage area of the satellite from the reference position.

In an embodiment, the determination module 620 is configured to, in response to the auxiliary information including the corresponding relationship information between the change information and access time parameter, determine that the UE is located in the coverage area of the target satellite of the preset cell according to the position information of the UE, and determine time information for accessing to the target satellite according to the access time parameter.

In an embodiment, the determination module 620 is configured to perform at least one of the following:
in response to the corresponding relationship information that indicates the corresponding relationship between the coverage area of the target satellite and the access time, it is determined that the UE is located in the coverage area of the target satellite of the preset cell according to the position information of the UE, and it is determined that an access request for accessing into the target satellite is initiated at the access time;
in response to the corresponding relationship information that indicates the corresponding relationship between the coverage area of the target satellite and the timing duration of the access timer, it is determined that the UE is located in the coverage area of the target satellite of the preset cell according to the position information of the UE, and it is determined that an access request for accessing to the target satellite is initiated when the access timer times out; or
in response to the corresponding relationship information that indicates the corresponding relationship between the coverage area of the target satellite and adjustment parameters of the access timer, it is determined that the UE is located in the coverage area of the target satellite of the preset cell according to the position information of the UE, the timing duration of the access timer is determined according to the public duration and the adjustment parameter, and it is determined that an access request for accessing to the target satellite is initiated when the access timer times out.

In an embodiment, the determination module 620 is configured to, in response to the auxiliary information including the change information of the coverage area of the target satellite, determine that the UE is located in the coverage area of the target satellite of the preset cell according to the position information of the UE and the change information of the coverage area of the target satellite, and determine time information of accessing to the target satellite in the preset cell according to the time offset of the access time among a plurality of coverages areas of the target satellite and the access time of at least one of the coverage areas, or, in response to the auxiliary information including the reference point information, the time information for the UE to access to the target satellite in the preset cell is determined according to the relative position relationship between the position information of the UE and a reference position indicated by the reference point information.

In an embodiment, the time information for accessing to the target satellite in the preset cell includes the following: absolute time information for accessing to the target satellite in the preset cell; timer information of the access timer accessing to the target satellite in the preset cell; and/or the adjustment parameter of the timing duration of the access timer accessing to the target satellite in the preset cell relative to the public duration.

In an embodiment, the determination module 620 is configured to determine that the UE is located in the preset cell according to the position information of the UE, and start the access timer according to the starting time information of the access timer included in the auxiliary information; and access to the target satellite in the preset cell when the access timer times out.

In an embodiment, the apparatus further includes: a starting module, configured to, in response to the auxiliary information not including the starting time information of the access timer, start the access timer when receiving the configuration information of the target satellite. The determination module 620, configured to, according to the duration of the access timer determined by the auxiliary information, when the access timer times out, determine that the UE is located in the preset cell according to the position information of the UE, and access to the target satellite in the preset cell.

In an embodiment, the absolute time indicated by the absolute time information includes: UTC.

In an embodiment, the receiving module 610 is configured to receive broadcast information containing the auxiliary information, or receive RRC information containing the auxiliary information.

As shown in FIG. 7, an embodiment of the present disclosure provides an auxiliary information processing apparatus 700. The auxiliary information processing apparatus 700 is performed by a network and includes a sending module 710.

The sending module 710 is configured to send auxiliary information for UE to access to NTN, where the auxiliary information is configured to determine time information for accessing to a target satellite in a preset cell by the UE according to self position information.

The auxiliary information processing apparatus 700 can be applied to an network device (access network device) of the NTN. The network device of the NTN includes but is not limited to a satellite.

In an embodiment, the sending module 710 includes, but is not limited to, a program module; after being executed by the processor, the program module can send auxiliary information for the UE to determine time information for accessing to the target satellite of the NTN.

In an embodiment, the sending module 710 includes and is not limited to a software and hardware combination module; the software and hardware combination module includes but is not limited to a programmable array; and the programmable array may include: a complex programmable array or a field programmable array.

In another embodiment, the sending module 710 may also be a pure hardware module; and the pure hardware module includes but is not limited to a specific integrated circuit.

In an embodiment, the auxiliary information includes at least one of the following: a cell identity of a preset cell, where the preset cell is: the cell where the UE is located when accessing to the target satellite; change information of the coverage area of the target satellite; corresponding relationship information between the change information and access time parameter, where the access time parameter indicates the time parameter for the UE to access to the target satellite in the preset cell; starting time information of an access timer accessing to the target satellite; duration information of public duration, where the public duration includes: duration from a preset time to a predicted time when the target satellite passes through a first reference position of the preset cell; or reference point information which is the position information of a second reference position of the preset cell.

In an embodiment, the corresponding relationship information between the change information and the access time parameter indicates at least one of the following: the corresponding relationship between the coverage area of the target satellite and the access time; the corresponding relationship between the coverage area of the target satellite and the timing duration of the access timer; or the corresponding relationship between the coverage area of the target satellite and adjustment parameters of the access timer, where the adjustment parameter indicates the adjustment parameter of the access timer relative to the public duration.

In an embodiment, the adjustment parameter includes: offset amount; and/or scaling proportion.

In an embodiment, the public duration: the duration between predicted time when the target satellite passes by the first reference position of the preset cell, as determined according to ephemeris information of the target satellite and the preset time.

In an embodiment, the preset time includes: current time; or, receiving time for configuration switch of the service link.

In an embodiment, the change information of the coverage area of the target satellite includes: a sequence of area information of a plurality of coverage areas passed by the target satellite in sequence.

In an embodiment, the area information includes at least one of the following:

The area information may be expressed as one of the following: the position information of the pole position of the polar coordinate system, the axial direction of the polar coordinate system, and the polar coordinates of the coverage area in the polar coordinate system; latitude and longitude of the coverage area; coordinates of the coverage area in the world coordinate system; or position information of a reference position and distance information of a reference distance of the coverage area.

In an embodiment, the pole position includes: the cell center of the preset cell; and/or, the axial direction includes: the projection direction of the moving direction of the satellite to the ground.

In an embodiment, the reference position includes: the first coverage position of the target satellite over the preset cell; and/or,

The reference distance includes: the nearest distance of the coverage area of the satellite from the reference position and the farthest distance of the coverage area of the satellite from the reference position.

In an embodiment, the sending module 710 is configured to send broadcast message containing the auxiliary information, or send RRC message containing the auxiliary information.

Considering that the next target satellite is fixed in SLS in the scenario of an earth moving cell, the change network in the coverage range of the satellite is also known.

Aiming at the above scenario, the embodiment of the present disclosure provides an enhanced method of triggering UE to access to a target satellite based on time/timer, considering the privacy and performance cost of the UE, in the solution, the UE does not need to report self position information, the UE determines the access time parameter based on the located area, and triggers the procedure of accessing to target satellite based on the parameter.

Considering the possibility that the UE may not be able to obtain or is not allowed to obtain ephemeris information of some satellites, the UE does not need to obtain ephemeris information of the satellites based on the area position configuration solution proposed in the embodiment of the present disclosure.

The UE determines time for the UE to initiate a procedure of accessing to target satellite according to self position information and auxiliary information provided by the network.

The auxiliary information includes at least one of the following: the cell ID of the cell where the UE is located and through which the target satellite passes; area information, configured for the UE to determine the located area; and a plurality of area information constitutes the change information provided by the foregoing embodiment; corresponding relationship between the area and the access time parameter, configured for the UE to determine the time parameter for accessing to the target satellite according to the area where the UE is located; starting time TO of a timer, configured for the UE to determine the starting time of the timer; public duration, configured for the UE to adjust the public duration according to the adjustment parameter of the timer to generate a specific timer of the UE, so as to trigger a procedure that the UE is accessed to the target satellite; and/or a position reference point, configured for the UE to obtain relative position relationship between self position and the reference point.

In an embodiment, the corresponding relationship between the area and the access time parameter may include at least one of the following: corresponding relationship between the area and access time, which refers to absolute time when the UE located in the area initiates a procedure of accessing to the target satellite; corresponding relationship between the area and the duration of the access timer, which refers to duration of the timer corresponding to the procedure of accessing to the target satellite initiated by the UE located in the area; or corresponding relationship between the area and the adjustment parameter of the access timer, which refers to the adjustment parameter of the timer corresponding to the procedure of accessing to the target satellite initiated by the UE located in the area.

In an embodiment, the area information may be determined by the following way: the area may be determined by a polar coordinate system with a certain position as a pole and a certain fixed direction as a polar axis direction by the network, and the pole position includes, but is not limited to, a center point of the cell. The polar axis direction may be the projection of the moving direction of the satellite on the ground, and may also be any other direction. The position of the polar coordinate system of network broadcast, i.e., pole position and polar axis direction. The range of the polar angle corresponding to each area position of network broadcast and the reference distance.

The area may also be determined by the network through a group of longitude and latitude on the ground or a group of fixed coordinates.

The area may also be determined by the network through the reference position and the reference distance, with the reference position as the center of the circle and the reference distance as the radius. The reference position may be the position where the target satellite first covers the preset cell.

In an embodiment, the public duration is determined by the network according to the ephemeris information of the satellite and using a position in the cell as a reference location, and the reference location for configuring the public duration may be a center point in the cell or another position in the cell.

In an embodiment, the auxiliary information may be provided to the UE through system broadcast or RRC message.

In an embodiment, in response to the corresponding relationship between the area and access time parameter is: the corresponding relationship between the area and access time, the network needs to configure the access configuration corresponding to the cell of the target satellite for the UE before the earliest absolute time in the corresponding relationship between the area and access time.

In an embodiment, in response to the corresponding relationship between the area and access time parameter is: the corresponding relationship between the area and access timer, or the corresponding relationship between the area and the adjustment parameter of the access timer, if the auxiliary information contains the starting time TO of the timer, and the network needs to configure the access configuration corresponding to the cell of the target satellite for the UE before TO.

The UE performs the accessing operation by combining with self position information after receiving the auxiliary information.

If the network provides the area information and the corresponding relationship between the area and the access time, the access operations are different for different types of corresponding relationship between the area and the access time.

For example, the UE performs the accessing operation by combining with self position information after receiving the auxiliary information may include at least one of the following:
in response to corresponding relationship between the area and access time parameter is: the corresponding relationship between the area and access time, the UE acquires the absolute time corresponding to the area, and initiates a procedure of accessing to the target satellite based on the time;
in response to corresponding relationship between the area and access time parameter is: the corresponding relationship between the area and the duration of the access timer, the UE acquires the duration of the timer corresponding to the located area, and triggers the procedure of accessing the UE to the target satellite based on the timer; or
in response to corresponding relationship between the area and access time parameter is: the corresponding relationship between the area and the adjustment parameter of the timer, the UE acquires the adjustment parameter of the timer corresponding to the located area, adjusts the public timer, obtains the timer for triggering accessing to the target satellite corresponding to the UE, and triggers the procedure of accessing the UE to the target satellite based on the timer.

If the network provides the area information, but does not provide the corresponding relationship between the area and the access time, the UE determines the absolute time for accessing to the satellite, duration of the timer, or scaling parameter of the timer according to located area. In this case, the network provides the public duration.

If the network provides the position reference point, the UE determines the absolute time for accessing to the satellite, duration of the timer, or scaling parameters of the timer according to the relative position relationship between self position and the reference point, in this case, the network provides the public duration.

In an embodiment, if the UE triggers the procedure of accessing to the cell of the target satellite based on the timer, the access operations performed may include at least one of the following: if the network provides the starting time TO of the timer, the UE starts the timer when reaching TO, when the timer times out, the procedure for the UE to access to the target satellite is triggered; if the network does not provide the starting time TO of the timer, the UE starts the timer when receiving the system message or RRC message correspondingly configured for accessing to the target satellite, and when the timer times out, the procedure for the UE to access to the target satellite is triggered; or in response to corresponding relationship between the area and access time parameter is: the corresponding relationship between the area and access time, if the UE initiates the procedure of accessing to the cell of the target satellite based on the absolute time, it initiates the procedure of accessing to the target satellite based on the time when the time is reached.

In an embodiment, the absolute time may be UTC time.

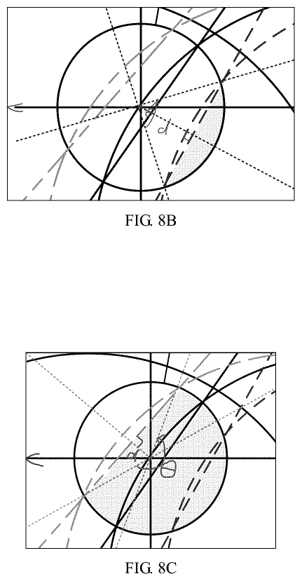

If the area is determined by a polar coordinate system with a certain position as a pole and a certain fixed direction as a polar axis direction of the network, the UE judges whether it belongs to the area or not according to the polar angle range corresponding to the area provided by the network in the order from small to large, as shown in FIG. 8A, FIG. 8B to FIG. 8C.

When the polar angle range corresponding to the area is smaller than or equal to π, the UE determines that the UE is located in the area by judging whether its position is within the polar angle range corresponding to a certain area of network configuration or not and the projection of the connecting line segment between the position of the UE and pole on the angle bisector of the angle where the area is located is greater than or equal to a reference distance. Otherwise, it is judged that the UE is not located in the area.

When the polar angle range is greater than π, the UE determines that the UE is located in the area by judging whether its position is within the polar angle range corresponding to a certain area of network configuration or not, or the projection of the connecting line segment between the position of the UE and pole on the angle bisector of the angle where the area is located is smaller than or equal to a reference distance. Otherwise, it is judged that the UE is not located in the area. As shown in FIG. 8A, the serving Satellite (SA) 0 covers the preset cell fixed on the ground, as time moves from T1 to T3 through T2, the target satellite SA1 gradually approaches the preset cell and covers the preset cell. As shown in FIGS. 8B and 8C, the coverage range of the target satellite SA1 for the preset cell gradually increases. The size of the coverage area is represented as the gray fill in the preset cell in FIGS. 8B and 8C. The coverage angle of SA1 to the preset cell ranges from angle δ to θ. The embodiment of the present disclosure further provides another access method for UE, specifically as follows.

The public duration of network broadcast is 100 ms, the starting time TO of the timer is 12:00:00:00 on Dec. 3, 2020, and the cell ID of the target satellite is Cell 1.

The area range information of network broadcast is shown in Table 1 below.

TABLE 1

| Area | Area position | | Adjustment |
|---|---|---|---|
| number | Polar angle range | Reference distance | parameter of timer |
| A | [−π/6, π/6] | 200 | 0.1 |
| B | [−π/3, π/3] | 100 | 0.4 |
| C | [−π/2, π/2] | 0 | 0.8 |
| D | [−2π/3, 2π/3] | 100 | 1.2 |
| E | [−5π/6, 5π/6] | 200 | 1.5 |
| F | [−π, π] | 300 | 1.9 |

The UE obtains self position and represents it by polar coordinate system of network broadcast as (π/4, 212.1).

Table 1 above is only an example, and any of the elements in Table 1 can be used alone or in combination.

The UE judges whether it is located in the area according to the order of the polar angle range from small to large. That is, from the order of A to F, first, it is judged that the UE is not in the polar angle range of A area, so the UE is not in the A area, it is judged that the UE is located in the polar angle range of B area. Meanwhile, the length of the projection of the connecting line segment between the position of the UE and pole on the angle bisector of the angle where the area is located is 150, which is smaller than 200. Therefore, the UE is located in the B area, the corresponding adjustment parameter of the timer is 0.4, and the access timer corresponding to the UE is 40 ms.

Before TO time, the network provides the configuration for the UE to access to the cell of the target satellite through RRC message in advance.

Before TO time, the UE starts the adjusted timer, when the timer times out, the procedure for the UE to access to the target satellite is triggered.

The embodiments of the present disclosure provide a communication device, including: a memory configured to store an instruction executable by a processor, and a processor, connected with the memory. The processor is configured to execute the access method and/or auxiliary information processing method provided by any of the foregoing technical solutions.

The processor may include various types of storage media. The storage media are non-temporary computer storage media, and may continue to store information stored in the communication device after the communication device is powered off.

The communication device here includes a network device or UE.

The processor may be connected to the memory by a bus or the like, and is configured to read the executable program stored on the memory, for example, at least one of the methods shown in FIG. 3 and/or FIG. 5.

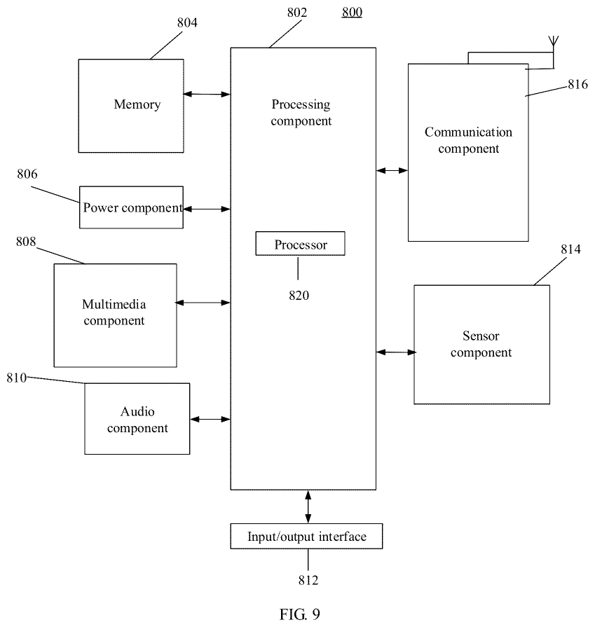

FIG. 9 is a block diagram of UE 800 according to an example. For instance, the UE 800 may be a mobile phone, a computer, a digital broadcast user device, a messaging device, a game console, a tablet device, a medical device, a fitness device, a personal digital assistant, etc.

Referring to FIG. 9, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls all operations of the UE 800, such as operations associated with display, telephone call, data communication, camera operation and recording operations. The processing component 802 may include one or more processors 820 configured to execute an instruction, so as to complete all or some steps of the method. In addition, the processing component 802 may include one or more modules to facilitate interaction between the processing component 802 and other components. For instance, the processing component 802 may include a multimedia module to facilitate interaction between the multimedia component 808 and the processing component 802.

The memory 804 is configured to store various types of data to support operations on the UE 800. Instances of the data include an instruction for any application or method operating on the UE 800, contact data, phone book data, a message, a picture, a video, etc. The memory 804 may be implemented through any type or combination of volatile or non-volatile memory devices, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 supplies power to various components of the UE 800. The power component 806 may include a power management system, one or more power supplies, and other components associated with power generation, management and distribution of the UE 800.

The multimedia component 808 includes a screen that provides an output interface between the UE 800 and a user. In some embodiments, the screen may include a liquid crystal display (LCD) and a touch panel (TP). If the screen includes a touch panel, the screen may be realized as a touch screen to receive input signals from the user. The touch panel includes one or more touch sensors to sense touch, sliding and gestures on the touch panel. The touch sensor may not only sense a boundary of the touch action or the sliding action, but also detect a duration and a pressure which are related to the touch operation or the sliding operation. In some embodiments, the multimedia component 808 includes a front camera and/or a rear camera. When the UE 800 is in an operation mode, such as a shooting mode or a video mode, the front camera and/or the rear camera may receive external multimedia data. Each front or rear camera may be a fixed optical lens system or have a focal length and optical zoom capability.

The audio component 810 is configured to output and/or input an audio signal. For instance, the audio component 810 includes a microphone (MIC). The microphone is configured to receive an external audio signal when the UE 800 is in operation modes such as a call mode, a recording mode and a voice identification mode. The received audio signal may be further stored in the memory 804 or transmitted via the communication component 816. In some examples, the audio component 810 further includes a speaker configured to output an audio signal.

The I/O interface 812 provides an interface between the processing component 802 and a peripheral interface module. The peripheral interface module may be a keyboard, a click wheel, a button, etc. The buttons may include, but are not limited to, a home button, a volume button, a start button, and a lock button.

The sensor component 814 includes one or more sensors for providing various aspects of status assessment for the UE 800. For instance, the sensor component 814 may detect an on/off state of the UE 800 and relative positioning of the components, such as a display and a keypad of the UE 800, and the sensor component 814 may further detect position change of the UE 800 or a component of the UE 800, presence or absence of contact between the user and the UE 800, an orientation or acceleration/deceleration of the UE 800, and temperature change of the UE 800. The sensor component 814 may include a proximity sensor configured to detect presence of a nearby object without any physical contact. The sensor component 814 may further include an optical sensor, such as a complementary metal-oxide-semiconductor (CMOS) or charge-coupled device (CCD) image sensor, which is used in imaging application. In some examples, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, the 2G, 3G, 4G, 5G, 6G or their combination. In an example, the communication component 816 receives broadcast signals or broadcast associated information from an external broadcast management system through a broadcast channel. In an example, the communication component 816 further includes a Near Field Communication (NFC) module to facilitate short-range communication. For example, the NFC module may be implemented based on Radio Frequency Identification (RFID) technology, Infrared Data Association (IrDA) technology, Ultra Wide Band (UWB) technology, Bluetooth (BT) technology, and other technologies.

In an example, the UE 800 may be implemented by one or more of an Application Specific Integrated Circuit (ASIC), a Digital Signal Processor (DSP), a Digital Signal Processing Device (DSPD), a Programmable Logic Device (PLD), a Field Programmable Gate Array (FPGA), a controller, a microcontroller, a microprocessor or other electronic components, thus executing the method.

In an example, there is further provided a non-transitory computer-readable storage medium including an instruction, such as the memory 804 including an instruction. The instruction may be executed by the processor 820 of the UE 800 so as to complete the method. For instance, the non-transitory computer-readable storage medium may be ROM, a random access memory (RAM), a compact disk (CD)-ROM, a magnetic tape, a floppy disk, an optical data storage device, etc.

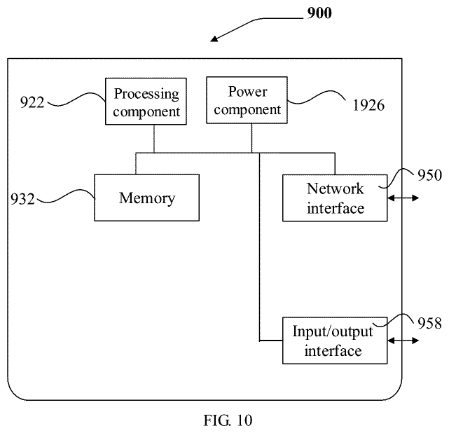

As shown in FIG. 10, an embodiment of the present disclosure shows a structure of a network device 900. For example, the satellite of the NTN is one of the network devices 900.

Referring to FIG. 10, the network device 900 includes a processing component 922, and further includes one or more processors, and a memory resource represented by a memory 932 and used for storing instructions capable of being executed by the processing component 922, such as application programs. The applications stored in the memory 932 may include one or more modules that each corresponds to a group of instructions. In addition, the processing component 922 is configured to execute instructions, to execute any methods applied to the base station of the above methods, such as the methods shown in FIG. 3 and/or FIG. 5.

The network device 900 may further include a power component 1926 configured to execute power supply management of the network device 900, a wired or wireless network interface 950 configured to connect the network device 900 to a network, and an input/output (I/O) interface 958. The network device 900 may operate an operating system stored on the memory 932, such as Windows Server™, Mac OS X™, Unix™, Linux™, FreeBSD™ or the like.

Those skilled in the art would readily conceive of other implementations of the present disclosure after considering the specification and practicing the disclosure disclosed here. The present disclosure is intended to cover any variations, uses or adaptive changes of the present disclosure. These variations, uses or adaptive changes follow the general principle of the present disclosure and include common general knowledge or conventional technical means in the technical field that are not disclosed in the present disclosure. The description and the embodiments are merely regarded as illustrative, and the real scope and spirit of the disclosure are pointed out by the following claims.

It should be understood that the present disclosure is not limited to the precise structure described above and shown in the figures, and various modifications and changes can be made without departing from its scope. The scope of the present disclosure is only limited by the appended claims.

1. An access method, performed by User Equipment (UE), comprising:
receiving auxiliary information for the UE to access to a non-terrestrial network (NTN); and
determining time information for accessing a target satellite according to position information of the UE and the auxiliary information.

2. The method according to claim 1, wherein the auxiliary information comprises at least one of the following:
a cell identity of a preset cell; wherein the preset cell is: the cell where the UE is located when accessing to the target satellite;
change information of a coverage area of the target satellite;
corresponding relationship information between the change information and access time parameter; wherein the access time parameter indicates the time parameter for the UE to access to the target satellite in the preset cell;
starting time information of an access timer accessing to the target satellite;
duration information of public duration; wherein the public duration comprises: duration from a preset time to a predicted time when the target satellite passes through a first reference position of the preset cell; or
reference point information which is the position information of a second reference position of the preset cell.

3. The method according to claim 2, wherein the corresponding relationship information between the change information and the access time parameter indicates at least one of the following:
the corresponding relationship between the coverage area of the target satellite and access time;
the corresponding relationship between the coverage area of the target satellite and timing duration of the access timer; or
the corresponding relationship between the coverage area of the target satellite and adjustment parameters of the access timer; wherein the adjustment parameter indicates the adjustment parameter of the access timer relative to the public duration;
wherein the adjustment parameter comprises at least one of an offset amount or a scaling proportion;
wherein the public duration is a duration between the predicted time when the target satellite passes by the first reference position of the preset cell, as determined according to ephemeris information of the target satellite and the preset time.

4-5. (canceled)

6. The method according to claim 2, wherein the preset time comprises:
current time; or
receiving time for configuration switch of a service link.

7. The method according to claim 2, wherein change information of the coverage area of the target satellite comprises:
a sequence of area information of a plurality of coverage areas passed by the target satellite in sequence;
wherein the area information comprises at least one of the following:
the position information of a pole position of a polar coordinate system, an axial direction of the polar coordinate system, and polar coordinates of the coverage area in the polar coordinate system;
latitude and longitude of the coverage area;
coordinates of the coverage area in the world coordinate system; or
position information of a reference position and distance information of a reference distance of the coverage area;
wherein the pole position comprises: a cell center of the preset cell, and
wherein the axial direction comprises a projection direction of a moving direction of the satellite to the ground.

8-9. (canceled)

10. The method according to claim 7, wherein
the reference position comprises: a first coverage position of the target satellite over the preset cell; and
the reference distance comprises: the nearest distance of the coverage area of the satellite from the reference position and the farthest distance of the coverage area of the satellite from the reference position.

11. The method according to claim 2, wherein
determining time information for accessing to a target satellite according to position information of the UE and the auxiliary information comprises:
in response to the auxiliary information comprising the corresponding relationship information between the change information and access time parameter, determining that the UE is located in the coverage area of the target satellite of the preset cell according to the position information of the UE, and determining time information for accessing to the target satellite according to the access time parameter.

12. The method according to claim 11, wherein that in response to the auxiliary information comprising the corresponding relationship information between the change information and access time parameter, determining that the UE is located in the coverage area of the target satellite of the preset cell according to the position information of the UE, and determining time information for accessing to the target satellite according to the access time parameter comprises at least one of the following:
in response to the corresponding relationship information indicates the corresponding relationship between the coverage area of the target satellite and the access time, determining that the UE is located in the coverage area of the target satellite of the preset cell according to the position information of the UE, and determining that an access request for accessing into the target satellite is initiated at the access time;
in response to the corresponding relationship information indicates the corresponding relationship between the coverage area of the target satellite and the timing duration of the access timer, determining that the UE is located in the coverage area of the target satellite of the preset cell according to the position information of the UE, and determining that an access request for accessing into the target satellite is initiated when access timer times out; or
in response to the corresponding relationship information indicates the corresponding relationship between the coverage area of the target satellite and adjustment parameters of the access timer, determining that the UE is located in the coverage area of the target satellite of the preset cell according to the position information of the UE, determining the timing duration of the access timer according to the public duration and the adjustment parameter, and determining that an access request for accessing to the target satellite is initiated when the access timer times out.

13. The method according to claim 2, wherein the determining time information for accessing to a target satellite according to position information of the UE and the auxiliary information comprises:
in response to the auxiliary information comprising the change information of the coverage area of the target satellite, determining that the UE is located in the coverage area of the target satellite of the preset cell according to the position information of the UE and the change information of the coverage area of the target satellite, and determining time information for accessing to the target satellite in the preset cell according to the time offset of the access time among a plurality of coverages areas of the target satellite and the access time of at least one of the coverage areas; or,
in response to the auxiliary information comprising the reference point information, determining the time information for the UE to access to the target satellite in the preset cell according to a relative position relationship between the position information of the UE and a reference position indicated by the reference point information.

14. The method according to claim 13, wherein the time information for accessing to the target satellite in the preset cell comprises the following:
absolute time information for accessing to the target satellite in the preset cell;
timer information of the access timer accessing to the target satellite in the preset cell; and
an adjustment parameter of the timing duration of the access timer accessing to the target satellite in the preset cell relative to the public duration.

15. The method according to claim 2, wherein the determining time information for accessing to a target satellite according to position information of the UE and the auxiliary information comprises:
determining that the UE is located in the preset cell according to the position information of the UE, and starting the access timer according to the starting time information of the access timer included in the auxiliary information; and
accessing into the target satellite in the preset cell when the access timer times out.

16. The method according to claim 2, further comprising:
in response to the auxiliary information not comprising the starting time information of the access timer, starting the access timer when the configuration information of the target satellite is received;
determining time information for accessing to a target satellite according to position information of the UE and the auxiliary information comprises:
according to the duration of the access timer determined by the auxiliary information, when the access timer times out, determining that the UE is located in the preset cell according to the position information of the UE, and accessing into the target satellite in the preset cell.

17. An auxiliary information processing method, performed by a network and comprising:
sending auxiliary information for UE to access to NTN, wherein the auxiliary information is configured for the UE to determine time information for accessing to a target satellite in a preset cell according to self position information.

18. The method according to claim 17, wherein the auxiliary information comprises at least one of the following:
a cell identity of a preset cell; wherein the preset cell is: the cell where the UE is located when accessing to the target satellite;
change information of a coverage area of the target satellite;
corresponding relationship information between the change information and access time parameter; wherein the access time parameter indicates the time parameter for the UE to access to the target satellite in the preset cell;
starting time information of an access timer accessing to the target satellite;
duration information of public duration; wherein the public duration comprises: duration from a preset time to a predicted time when the target satellite passes through a first reference position of the preset cell; or
reference point information which is the position information of a second reference position of the preset cell.

19. The method according to claim 18, wherein
the corresponding relationship information between the change information and the access time parameter indicates at least one of the following:
the corresponding relationship between the coverage area of the target satellite and the access time;
the corresponding relationship between the coverage area of the target satellite and the timing duration of the access timer; or
the corresponding relationship between the coverage area of the target satellite and adjustment parameters of the access timer; wherein the adjustment parameter indicates the adjustment parameter of the access timer relative to the public duration;
wherein the adjustment parameter comprises at least one of and offset amount, or a scaling proportion; and
wherein, the public duration: duration between the predicted time when the target satellite passes by the first reference position of the preset cell, as determined according to ephemeris information of the target satellite and the preset time.

20-21. (canceled)

22. The method according to claim 19, wherein the preset time comprises:
current time; or
receiving time for configuration switch of a service link.

23. The method according to claim 19, wherein change information of the coverage area of the target satellite comprises:
a sequence of area information of a plurality of coverage areas passed by the target satellite in sequence;
wherein the area information comprises at least one of the following:
the position information of a pole position of a polar coordinate system, an axial direction of the polar coordinate system, and polar coordinates of the coverage area in the polar coordinate system;
latitude and longitude of the coverage area;
coordinates of the coverage area in the world coordinate system; or
position information of a reference position and distance information of a reference distance of the coverage area;
wherein the pole position comprises: a cell center of the preset cell; and
wherein the axial direction comprises: a projection direction of a moving direction of the satellite to the ground.

24-25. (canceled)

26. The method according to claim 23, wherein
the reference position comprises: a first coverage position of the target satellite over the preset cell; and
the reference distance comprises: the nearest distance of the coverage area of the satellite from the reference position and the farthest distance of the coverage area of the satellite from the reference position.

27-32. (canceled)

33. A user equipment (UE), comprising a processor, a transceiver, a memory, and executable programs stored in the memory and can be executed by the processor, wherein when the processor executes the executable programs, the processor is caused to:
receive auxiliary information for the UE to access to a non-terrestrial network (NTN); and
determine time information for accessing to a target satellite according to position information of the UE and the auxiliary information.

34. (canceled)

35. A network, comprising a processor, a transceiver, a memory, and executable programs stored in the memory and can be executed by the processor, wherein when the processor executes the executable programs, the method according to claim 17 is performed.
